(19) United States
(12) Patent Application Publication
(10) Pub. No.: US 2013/0170075 A1
(43) Pub. Date: Jul. 4, 2013

(54) SYSTEM, METHOD AND APPARATUS FOR MAGNETIC MEDIA WITH A NON-CONTINUOUS METALLIC SEED LAYER

(71) Applicants: Qing Dai, San Jose, CA (US); Oleksandr Mosendz, San Jose, CA (US); Simone Pisana, San Jose, CA (US); Dieter K. Weller, San Jose, CA (US)

(72) Inventors: Qing Dai, San Jose, CA (US); Oleksandr Mosendz, San Jose, CA (US); Simone Pisana, San Jose, CA (US); Dieter K. Weller, San Jose, CA (US)

(73) Assignee: Hitachi Global Storage Technologies Netherlands B.V., Amsterdam (NL)

(21) Appl. No.: 13/338,893

(22) Filed: Dec. 28, 2011

(51) Int. Cl. G11B 5/48; G11B 5/65

(52) U.S. Cl. 360/244; 428/836; 428/836.2; G9B/5.147; G9B/5.236

(57) ABSTRACT

A magnetic media has a substrate with an underlayer and a seed layer on the underlayer. The seed layer has a non-continuous metallic layer with a cubed crystalline lattice that is 001 textured, and has a lattice mismatch within 15% of a crystalline lattice structure of FePt with a metallic additive. This structure defines nucleation sites with an established epitaxial interface.

### BACKGROUND OF THE INVENTION

1. Field of the Disclosure

The present invention relates in general to disk drives and, in particular, to a system, method and apparatus for magnetic media having a non-continuous metallic seed layer.

2. Description of the Related Art

In hard disk drives, fabrication of very small grain media is useful to implement recording densities that exceed 1 Tb/in². One possible candidate for such media is an FePt L1₀-ordered alloy. High temperature deposition facilitates chemical ordering, which tends to increase grain size. On the other hand, segregant materials such as carbon allow for smaller grains. However, carbon graphitizes when deposited at elevated temperature and encapsulates the FePt grains. Due to the very low energy of the graphitic carbon surrounding the grain, the FePt tends to self-organize into spherical particles. This leads to decreased contact area between the FePt grains and the MgO underlayer. As a result, the texture and magnetic properties of the FePt—C media are degraded.

To address this issue, segregant alternatives to carbon, such as SiO₂, Ta₂O₅ and others may be used to modify the interface energy in FePt/MgO segregant systems. Although these alternatives result in better wetting and increased contact area between FePt and MgO, chemical ordering for this media and grain segregation are poor. Oxide segregants also may lead to oxidation of Fe, which is promoted by high deposition temperature. Thus, improvements in fabricating small grain media for disk drives continue to be of interest.

### SUMMARY

Embodiments of a system, method and apparatus for magnetic media having a non-continuous metallic seed layer are disclosed. In some embodiments, the magnetic media may comprise a substrate having an underlayer and a seed layer on the underlayer. The seed layer may comprise a non-continuous metallic layer with a cubed crystalline lattice that is 001 textured. The layer also may have a lattice mismatch within 15% of a crystalline lattice structure of FePt or FePt—X with a metallic additive, where X may comprise Cu, Ni, Ag or a combination thereof. The non-continuous metallic layer defines nucleation sites with an established epitaxial interface. Additionally, the seed layer may have a thickness of 5 nm or less. In other embodiments, one or more segregant-free layers may be deposited within one deposition cycle of the magnetic layer.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a schematic sectional side view of a conventional media;

FIGS. 2A and 2B are schematic top and sectional side views of an embodiment of media;

FIGS. 3A and 3B are schematic sectional side views of another embodiment of media;

FIGS. 4A-4F are sectional microscopic images of various media;

FIG. 5 are hysteresis loops of the performance of various media;

FIG. 6 is a top view microscopic image of an embodiment of media; and

FIG. 7 is a schematic diagram of an embodiment of a disk drive.

The use of the same reference symbols in different drawings indicates similar or identical items.

### DETAILED DESCRIPTION

Embodiments of a system, method and apparatus for magnetic media having a non-continuous metallic seed layer are disclosed. FIG. 1 depicts a conventional grain structure of grains 11a, 11b for a magnetic layer 15 grown on a textured underlayer 13. In this prior art example, the grains comprise FePt and the magnetic layer is FePt—X—C, where X is a metallic additive and C is carbon.

Small contact area between the grains 11a and the underlayer 13 results in in poor texture. Moreover, the size of the grains 11a, 11b varies significantly due to random nucleation and subsequent isolation of the grains by carbon. This results in non-uniform nucleation of a second layer of grains 11b (which are not in contact with underlayer 13), which roughens the surface of the media.

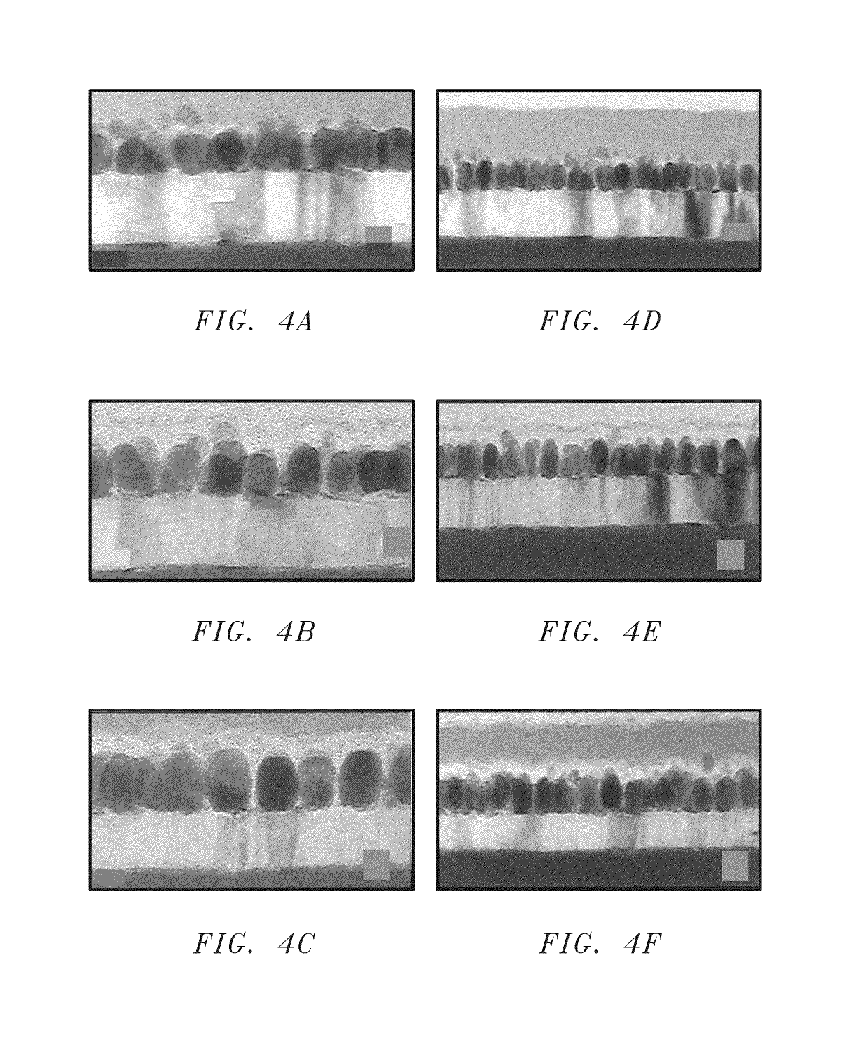

FIGS. 4A and 4D depict sectional TEM images of the conventional grain structure of FIG. 1. The second layer of grains 11b is undesirable for several reasons: (a) it is not textured and has no contact with the texture-defining underlayer; (b) it results in increased media roughness; and (c) it can overlap with underlying grains to limit linear densities. In addition, the small contact area between the grains and the underlayer reduces texture-copying in the grains from the underlayer and leads to misoriented grains. These grains are misoriented due to their texture being induced by the underlayer. When the contact area between the magnetic grains and the underlayer is reduced, the texture-defining property of the underlayer also is reduced.

In order to improve grain size distribution, roughness and contact area between the magnetic grains and the underlayer, embodiments of a non-continuous seed layer may be used in the process of forming a magnetic layer. Some embodiments of the non-continuous seed layer do not contain intergranular materials like carbon.

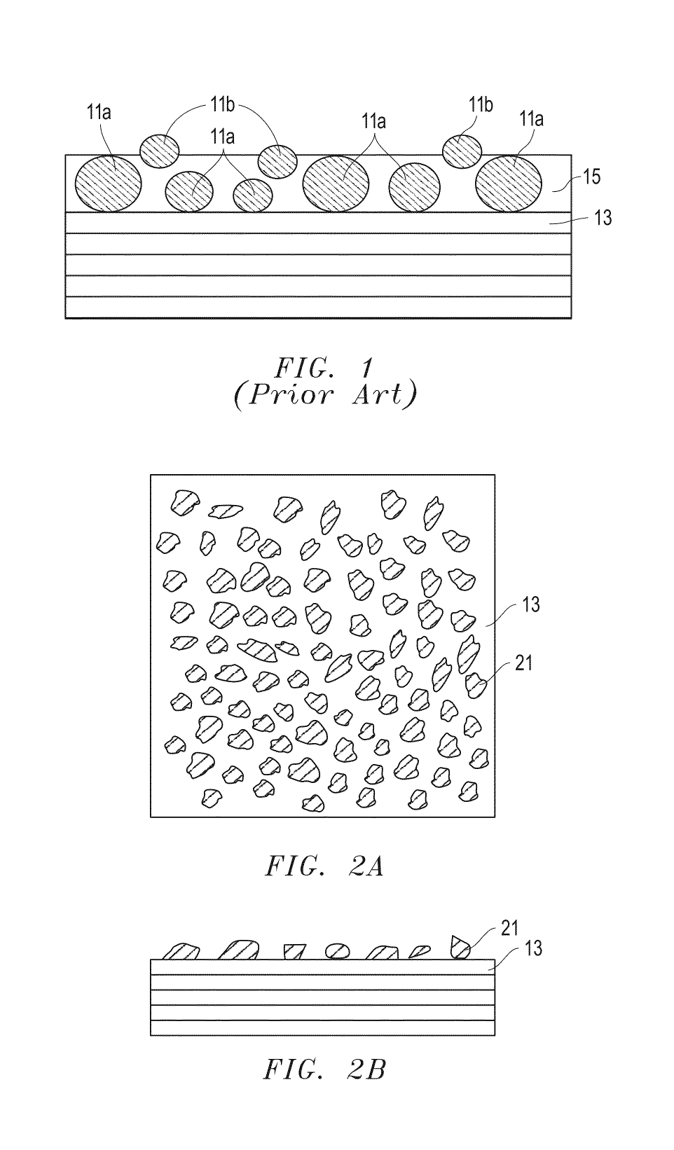

For example, FIGS. 2A and 2B depict a particulate or “non-continuous” seed layer 21 deposited on a textured underlayer 13. The seed layer 21 may comprise, for example, FePt or FePt—X, where X comprises a metallic additive. Contact area between the seed layer and the underlayer is typically defined by dewetting properties. Contact area at the interface between layers 13 and 21 is not affected by the low surface energy of the intergranular segregant materials, since it is omitted in the seed layer 21. Since segregants do not interfere with seed formation, the grain size distribution of the seeds follows a normal distribution.

The seed layer 21 self-organizes into particles or non-continuous seeds on the textured underlayer 13. This self-organization is primarily due to dewetting properties. In the absence of carbon or other segregants and due to the epitaxy between the seed layer and the underlayer, spherical-shaped contact between nucleation sites at the interfaces (as shown in prior art FIG. 1) is avoided. Instead, particles with flat extended interface are formed as shown in FIG. 2B with seed layer 21. The separated seeds may have grain sizes or diameters of about 1 nm to about 8 nm, in some embodiments.

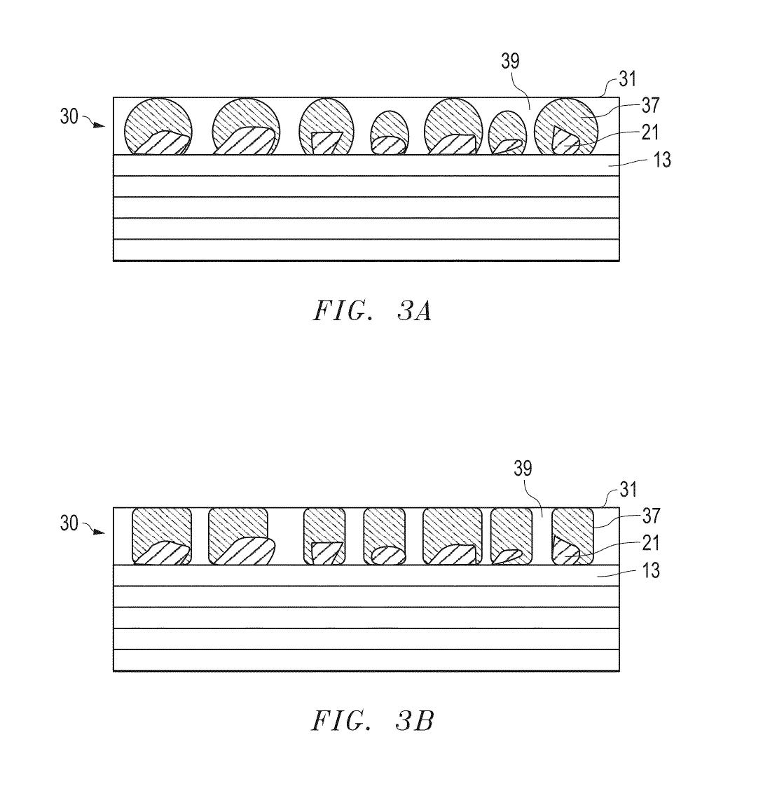

After the initial seed particulate layer 21 is formed, an intergranular segregant 39 (FIGS. 3A and 3B) may then be introduced to the magnetic film. In FIG. 3A, the segregant 39 may comprise carbon or other materials. In FIG. 3B, the segregant 39 may comprise a mixture or lamination of carbon with SiO₂, TaOₓ, TiO₂, BN, or other materials, which can modify grain shape and induce more columnar grain growth, as shown.

The segregant 39 may be introduced by finishing the magnetic layer 30 with a material such as a composite film 31. In some embodiments, film 31 may comprise FePt—X—Y, where FePt—X is depicted as element 37 and Y is depicted as element 39. In some versions, the film 31 may comprise a total thickness of up to about 10 nm of composite material, with Y 39 comprising about 20% to 50% of the volume of the composite film.

Film 31 may be grown on a segregant-free FePt layer 21, which is deposited on underlayer 13. Embodiments of FePt—X seeds 21 produce FePt—X grains 37 in the segregant 39. FIG. 3A illustrates the case where the segregant 39 is carbon. Comparing the resulting grains 37 of FIG. 3A to grains 11 of FIG. 1 (which depicts media without a segregant-free seed layer), grains 37 have greater contact area with the underlayer 13 than grains 11.

Depositing a seed layer in the manner described forms the non-continuous seeds 21 (FIGS. 2A and 2B). Introducing the non-continuous seeds 21 also defines the minimum grain size and, ultimately, the particle size of the subsequently deposited full grain 37 (FIGS. 3A and 3B). Their sizes are related since the additional material 37 deposited grows from the seeds 21, and can only increase in size from the initial size of the seeds 21. Such mechanisms allow for control of the size of the FePt or FePt—X grains 37 by the seed layer 21. Optimization of the number of seeds 21, their size and the distance between them enables suppression of the undesirable smaller grains (e.g., grain diameters below 3 nm) in magnetic layer 30, which helps avoid the superparamagnetism effect.

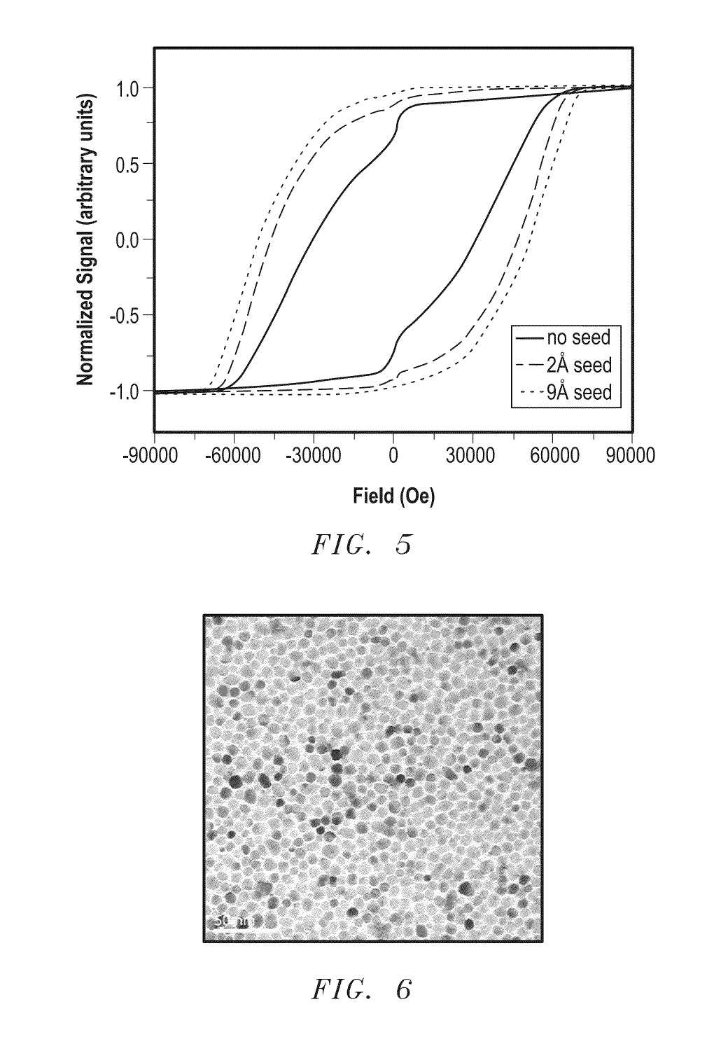

FIG. 5 depicts hysteresis loops of magnetic properties of a sample without a seed layer and for samples having two different seed layer thicknesses. Clear improvement in remnant magnetization is observed due to suppression of very small grains and improved 001 orientation of FePt grains. The term “001 textured” means that the preferential crystallographic direction of the formed particles is 001. A coercive field of 5.1 T was achieved in granular film as can be seen for the sample with the 9 Å seed layer. This is about 10 times higher than current PMR media and warrants thermal stability for small grain media. Increasing the thickness of the seed layer reduces superparamagnetism and increases coercivity.

Again referring to FIG. 4, additional samples with different thicknesses of segregant-free seed layers are shown. As noted above, FIGS. 4A and 4D are images of a conventional sample that lacks non-continuous seed layers. FIGS. 4B and 4E show a sample with a 2 Å non-continuous seed layer. FIGS. 4C and 4F show a sample with a 9 Å non-continuous FePt—X seed layer, where X is a metallic additive. In these examples, the segregant is pure carbon. The contact area between the seeds and the underlayers is extended for samples with thicker seed layers. The samples with 9 Å seed layers (FIGS. 4C and 4F) have grains with more columnar-like shapes compared to the samples (FIGS. 4A and 4D) with no segregant-free seed layers.

The embodiment of FIG. 3A is supported by the images shown in FIGS. 4B, 4C, 4E and 4F. Advantages of this embodiment include increased contact area between the FePt—X grains and the underlayer, partial-suppression of a second layer of grains, and reduction of the number of grains having diameters of less than 3 nm.

FIG. 6 is a top view image of the sample of FIGS. 4C and 4F. It has a 9 Å FePt—X seed layer followed by a 6 nm FePt—X—C layer with 36% carbon. The spacing between the grains is rather narrow. Even though carbon was not used in the seed layer, the resulting structure has intergranular carbon throughout the film thickness and shows good grain isolation.

Filling factor is defined as the percentage of grains in the magnetic layer. The filling factor for the sample having a 9 Å seed layer thickness is 67%, but only 60% for the sample having a 2 Å seed layer thickness. Higher filling factors are beneficial for readback signals from the media. Thus, optimization of C segregant and seed layer thickness allows for more narrow grain boundaries for media with higher amounts of segregant, which is typical for FePt L1₀-based media.

Improved grain size distribution also suppresses formation of the undesirable second layer of grains. Suppression of second layer grains is confirmed by reduced roughness of the film, as can be seen in Table 1.

TABLE 1
Roughness measured on 1 μm² area with AFM.

| Seed layer thickness (Å) | Rp (nm) | Rv (nm) | Rq (nm) |
|---|---|---|---|
| 3 | 9.65 | 3.65 | 1.20 |
| 6 | 6.20 | 3.08 | 1.08 |
| 9 | 5.16 | 3.29 | 1.10 |
| 12 | 5.72 | 3.25 | 1.14 |

In the samples of Table 1, the thickness of a FePt—X seed layer was varied between 3 Å and 12 Å. Each sample also had the same FePt—X—Y layer deposited subsequently. Note that even though the total amount of material used for the seed layer increases, roughness on the media has a minimum value for the 9 Å seed layer.

In some embodiments, a segregant-free seed layer of FePt—X may be used, where X comprises a metallic additive (e.g., Cu, Ag, Mn, Ni, etc.). One or more segregant-free layers may be deposited within one deposition cycle of the magnetic layer.

Embodiments of the seed layer may be grown on an underlayer comprising, e.g., MgO, TiN, TiC and/or other materials. This defines textured FePt L1₀ nucleation sites with an established interface. When a conventional thick layer of FePt without segregant is deposited it will form a continuous film, which will disrupt the granular nature of the media. However, in the present approach, a thin layer (e.g., less than 1.5 nm of FePt) may be used so that it forms a non-continuous seed layer. When such thin layers are deposited at high temperatures (e.g., about 400-600° C.), FePt segregates into small particles instead of a continuous film. The dewetting properties at the interface allows for the formation of thin, well-established particulate layers.

Subsequently, materials such as FePt or FePt—X may be deposited with carbon or another segregant on the particulate template (which is the non-continuous seed layer). This enables better wetting, improved film roughness and consequently improved magnetic properties of the granular media. Thus, some embodiments have a segregant-free layer to improve magnetic and structural properties of FePt—X—Y media, where X comprises a metallic additive and Y comprises an insulating segregant material (e.g., C, SiO₂, BN, SiN, TaOₓ, or mixtures thereof).

Such designs have several advantages for thermally-assisted recording (TAR) media based on FePt L1₀ phase media. For example, when a segregant-free FePt—X seed layer is used epitaxy is improved between the FePt grains and the underlayer. There is also suppression of a second layer of grains, reduced roughness, reduced paramagnetic grains with diameters of about 2 to 5 nm, improved filling factor of the magnetic material in the magnetic layer, and improved remnant magnetization.

Magnetic media for TAR applications based on a FePt L1₀ magnetic layer is typically deposited on a textured underlayer such as MgO, TiN or TiC. The high anisotropy, L1₀ phase of FePt requires high temperature deposition, typically in the range from about 400 to 600° C. Insulators or materials with high melting points are typically chosen for the underlayer to avoid interdiffusion between the magnetic FePt layer and the underlayer at high deposition temperatures. Surface energies for metallic materials (high surface energy) and insulating materials (low surface energy) are rather different, which leads to poor wetting of the underlayers by the FePt film.

Thus, when a low surface energy segregant (such as carbon) is added to the film to promote grain segregation in the magnetic layer, FePt grains self-organize into spheres surrounded by C to minimize the high energy surface of the FePt. Apart from energy considerations, such mechanisms as graphitic C onion formation around FePt promote the spherical shape of FePt grains since graphitic C has very low surface energy. Graphitic C onions are stable at the high temperatures used in deposition processes. If an onion fully encapsulates a grain of any size it will limit its growth in lateral and vertical directions.

Since underlayers do not define grain size and serve primarily as a texture defining layer (depicted as horizontal lines in FIGS. 1-3), grain size distribution is controlled primarily by self-organization of FePt inside the C matrix. Due to C onion formation spherical grain shape and grain size may differ significantly from grain to grain. As a result, encapsulation of grains in the second layer of FePt grains is formed.

In addition, the seed layer may have a lattice mismatch within 15% of a crystalline lattice structure of FePt with a metallic additive. In other words, the dimension of the crystallographic unit cell for the seed layer is within 15% of that for FePt—X. This defines nucleation sites with an established epitaxial interface since the FePt grain has straight boundaries (FIGS. 3A and 4C) at the contact with the underlayer. This contrasts with the ball-like contact of FIGS. 1 and 4A. In addition, the seed layer may have a thickness of 5 nm or less. In other embodiments the seed layer thickness is 1.5 nm or less.

Embodiments of the seed layer may be segregant-free. The seed layer may comprise FePt—X, where X comprises the metallic additive, to define FePt L1₀ nucleation sites. The seed layer also may comprise Pt, FeMn or FeMn—X, where X comprises the metallic additive.

The media may further comprise deposition of FePt—X (where X comprises the metallic additive) with segregant after the seed layer. The segregant may be carbon. The segregant also may be a mixture or lamination of carbon with SiO₂, TaOₓ, TiO₂, BN, BC, BOₓ, B or mixtures of these materials. In other embodiments, the segregant is without carbon and comprises SiO₂, TaOₓ, TiO₂, BN, BC, BOₓ, B or mixtures of these materials.

The magnetic media may further comprise a composite film directly on the seed layer, and an insulating segregant. The magnetic layer 30 (e.g., the combined seed layer, composite film and segregant) may have a total thickness of 20 nm or less, or about 15 nm or less in other embodiments. The composite film may comprise FePt—X—Y directly on the seed layer, where X comprises the metallic additive, and where Y comprises an insulating segregant material. Y may comprise about 20% to about 50%, or about 25% to about 50% of the volume of the composite film. Grains of the seed layer may have a diameter of about 2 nm to about 5 nm.

The underlayer may comprise textured MgO, TiN or TiC, and the seed layer may be deposited on the underlayer by methods such as by sputtering. The magnetic layer may have a total thickness of up to about 20 nm of composite material, or about 15 nm or less in other embodiments. The seed layer may be deposited at a temperature of about 300-600° C.

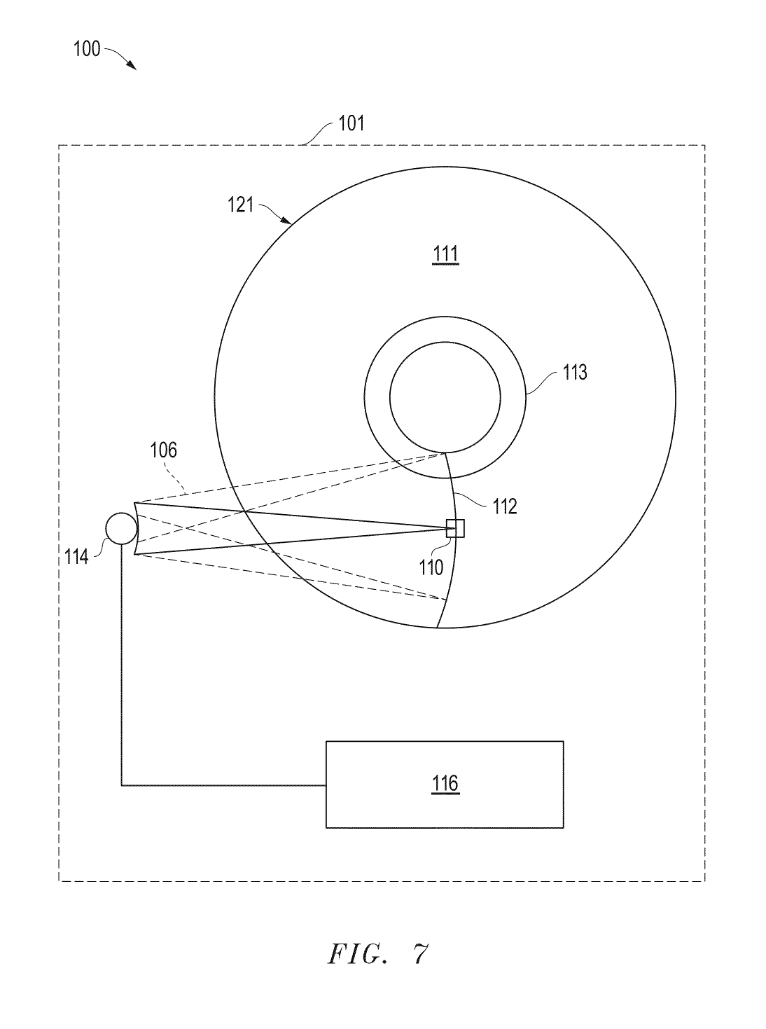

FIG. 7 depicts a hard disk drive assembly 100 comprising a housing or enclosure 101 with one or more media disks 111 rotatably mounted thereto. The disk 111 comprises magnetic recording media as described herein. The disk 111 is rotated at high speeds by a spindle motor (not shown) during operation. Concentric magnetic data tracks 113 are formed on either or both of the disk surfaces to receive and store information.

Embodiments of a read/write slider 110 having read/write heads may be moved across the disk surface by an actuator assembly 106, allowing the slider 110 to read and/or write magnetic data to a particular track 113. The actuator assembly 106 may pivot on a pivot 114. The actuator assembly 106 may form part of a closed loop feedback system, known as servo control, which dynamically positions the read/write slider 110 to compensate for thermal expansion of the magnetic recording media 111 as well as vibrations and other disturbances or irregularities. Also involved in the servo control system is a complex computational algorithm executed by a microprocessor, digital signal processor, or analog signal processor 116 that receives data address information from a computer, converts it to a location on the disk 111, and moves the read/write slider 110 accordingly.

In some embodiments of hard disk drive systems, read/write sliders 110 periodically reference servo patterns recorded on the disk to ensure accurate slider positioning. Servo patterns may be used to ensure a read/write slider 110 follows a particular track 113 accurately, and to control and monitor transition of the slider 110 from one track to another. Upon referencing a servo pattern, the read/write slider 110 obtains head position information that enables the control circuitry 116 to subsequently realign the slider 110 to correct any detected error.

Servo patterns or servo sectors may be contained in engineered servo sections 112 that are embedded within a plurality of data tracks 113 to allow frequent sampling of the servo patterns for improved disk drive performance, in some embodiments. In a typical magnetic recording media 111, embedded servo sections 112 may extend substantially radially from the center of the magnetic recording media 111, like spokes from the center of a wheel. Unlike spokes however, servo sections 112 form a subtle, arc-shaped path calibrated to substantially match the range of motion of the read/write slider 110.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A magnetic media, comprising:
an underlayer;
a seed layer on the underlayer, the seed layer comprising a non-continuous metallic layer, to define nucleation sites with an established epitaxial interface; and
the seed layer has a thickness of 5 nm or less.

2. A magnetic media according to claim 1, wherein the seed layer has a cubed crystalline lattice that is 001 textured, and has a lattice mismatch within 15% of a crystalline lattice structure of FePt with a metallic additive.

3. A magnetic media according to claim 1, wherein the seed layer is segregant-free.

4. A magnetic media according to claim 1, wherein the seed layer comprises FePt or FePt—X, where X comprises a metallic additive, to define FePt L1₀ nucleation sites.

5. A magnetic media according to claim 1, wherein the seed layer comprises Pt, FeMn or FeMn—X, where X comprises a metallic additive.

6. A magnetic media according to claim 1, further comprising deposition of FePt—X (where X comprises a metallic additive) with a segregant after the seed layer; and the segregant comprises:
carbon;
a mixture or lamination of carbon with SiO₂, TaOₓ, TiO₂, BN, BC, BOₓ, B or mixtures thereof; or
no carbon and SiO₂, TaOₓ, TiO₂, BN, BC, BOₓ, B or mixtures thereof.

7. A magnetic media according to claim 1, further comprising a composite film directly on the seed layer including an insulating segregant; and
the seed layer, composite film and insulating segregant have a combined total thickness of 20 nm or less.

8. A magnetic media according to claim 1, further comprising a composite film of FePt—X—Y directly on the seed layer, where X comprises the metallic additive, and where Y comprises an insulating segregant material.

9. A magnetic media according to claim 8, wherein Y comprises about 20% to 50% of a volume of the composite film.

10. A magnetic media according to claim 1, wherein grains of the seed layer have a particle size of about 2 nm to about 5 nm.

11. A magnetic media according to claim 1, wherein the underlayer comprises textured MgO, TiN or TiC, and the seed layer is deposited on the underlayer.

12. A magnetic media according to claim 1, wherein the seed layer is deposited at a temperature of about 400-600° C.

13. A hard disk drive, comprising:
an enclosure;
a magnetic media disk rotatably mounted to the enclosure and having a substrate, and a recording magnetic media on the substrate comprising:
an underlayer;
a seed layer on the underlayer, the seed layer comprising a non-continuous metallic layer to define nucleation sites with an established epitaxial interface; and
the seed layer has a thickness of 5 nm or less; and
an actuator pivotally mounted to the enclosure and having a head configured to read data from the magnetic media disk.

14. A hard disk drive according to claim 13, wherein the seed layer has a cubed crystalline lattice that is 001 textured, and has a lattice mismatch within 15% of a crystalline lattice structure of FePt with a metallic additive.

15. A hard disk drive according to claim 13, wherein grains of the seed layer have a particle size of about 2 nm to about 5 nm, and the underlayer comprises textured MgO, TiN or TiC.

16. A hard disk drive according to claim 13, wherein the seed layer is segregant-free, and the seed layer is deposited at a temperature of about 400-600° C.

17. A hard disk drive according to claim 13, wherein the seed layer comprises:
FePt—X, where X comprises a metallic additive, to define FePt L1₀ nucleation sites; or
Pt, FeMn or FeMn—X, where X comprises the metallic additive.

18. A hard disk drive according to claim 13, further comprising FePt—X (where X comprises a metallic additive) with segregant on the seed layer; and the segregant comprises:
carbon;
a mixture or lamination of carbon with SiO₂, TaOₓ, TiO₂, BN, BC, BOₓ, or mixtures thereof; or
no carbon and SiO₂, TaOₓ, TiO₂, BN, BC, BOₓ, or mixtures thereof.

19. A hard disk drive according to claim 13, further comprising a composite film directly on the seed layer including an insulating segregant; and
the seed layer, composite film and insulating segregant have a combined total thickness of 20 nm or less.

20. A hard disk drive according to claim 13, further comprising a composite film of FePt—X—Y directly on the seed layer, where X comprises the metallic additive, and where Y comprises an insulating segregant material; and
Y comprises about 20% to 50% of a volume of the composite film.
